(19) United States
(12) Patent Application Publication
(10) Pub. No.: US 2022/0276177 A1
(43) Pub. Date: Sep. 1, 2022

(54) COLORIMETRIC SENSOR FOR PH MEASUREMENTS

(71) Applicant: UNIVERSITÀ DEGLI STUDI DI PADOVA, Padova (IT)

(72) Inventors: Luca CAPPELLIN, Padova (IT); Paolo PASTORE, Padova (IT); Denis BADOCCO, Padova (IT); Andrea PASTORE, Padova (IT)

(73) Assignee: UNIVERSITÀ DEGLI STUDI DI PADOVA, Padova (IT)

(21) Appl. No.: 17/632,103

(22) PCT Filed: Aug. 3, 2020
(86) PCT No.: PCT/IB2020/057318

§ 371 Date: Feb. 1, 2022

(30) Foreign Application Priority Data
Aug. 2, 2019 (IT) 102019000013878

(51) Int. Cl. G01N 21/80; G01N 31/22

(52) U.S. Cl. CPC G01N 21/80; G01N 31/221

(57) ABSTRACT

The present invention relates to a colorimetric sensor for measuring pH based on the H coordinate of the HSV color space.

### TECHNICAL FIELD OF THE INVENTION

The present invention finds application in the field of optoelectronic sensors.

### BACKGROUND ART

A colorimetric sensor (CSA=Colorimetric Sensor Array) generally consists of a membrane, conveniently supported, characterized by the presence of sensitive molecules which take on a certain color depending on the concentration of the analyte in hand.

The immobilization of indicator molecules plays a key role in the analytical performance of a CSA.

In the literature, the arrays used include: cellulose acetate, sol-gel, PVC, acrylic-methacrylic copolymer and different compounds based on the system SiO₂/ZrO₂-styrene.

The various strategies used include the retention of the dye on ion exchange resins such as Amberlite or adsorption on materials such as styrene/divinylbenzene copolymer, cellulose, or cellulose acetate.

Lastly, it is also possible to create covalent bonds with the membrane using different polymers such as polyacrylamide, agarose, or polyamides.

In the latter case, although the leaching problem has been solved, the response times are very long (>>3 min).

The choice of an appropriate color space is equally crucial in the intent to create a sensor with accuracy comparable to the pH meter.

This aspect is very useful because it allows to minimize the problems associated with the acquisition of images by the device, the problem of sensor non-homogeneity due to the deposition technique used and the variation in the concentration of the indicator due to leaching.

However, in the presence of these phenomena, the color saturation value turns out to be significantly lower, leading to an increase in the error on the discriminated pH which is not resolved by the choice of the color space alone.

All the CSAs findable in the background art for pH determination are affected by multiple problems:
1. Narrow measuring range and/or
2. Low pH prediction accuracy (error>>0.02 pH units) and/or
3. Long response times and/or
4. Non reversibility and/or
5. Leaching for pH>9.
   The background art document by Issa M El Nahhal et al (“Sol-gel method optical BTB pH sensors in the presence of surfactants”, International Nano Letters, December 2012) describes some improvements of pH sensors made with thin sol-based TEOS gel films containing a pH indicator and a surfactant. The signal is not colorimetric since it involved the use of a spectrophotometer; therefore, a colorimetric sensor is not described. The colorimetric signal is provided by the color coordinates such as RGB, HSV, etc.

In the background art documents by GH Mohr et al

(“Adaptation of color variations of optical sensor materials by combining indicator and inert dyes and their use in woven and non-woven sensor layers”, Sensors and Actuators B, January 2015) and SONIA CAPEL-CUEVAS ET AL (“A compact optical instrument with artificial neural network for the determination of pH”, SENSORS, vol. 12, n. 5, 22 May 2012) the use of various individual indicators in each spot to read the pH value is described. On the contrary, in the device of the present invention, there is a modulation of the surfactant concentration, so that each spot is characterized by a different surfactant concentration, which produces a displacement of the calibration position. The modulation of the surfactant produces the variation of the indicator pKa which may be used in a wide range of pH.

### SUMMARY OF THE INVENTION

The authors of the present invention have surprisingly found that it is possible to obtain a colorimetric sensor which solves and overcomes the limits of the sensors of the background art.

### OBJECT OF THE INVENTION

A first object of the present invention is a colorimetric sensor comprising a colorimetric indicator and a surfactant.

In one aspect of the invention, this sensor is optimized by adding a colored species, which may be a dye or a second acid-base indicator.

According to a particular aspect of the present invention, there may be two or more than two added dyes.

For example, the dyes used may be Bromocresol Green and Methyl Red.

According to an aspect of the present invention, the further dye is added at a suitable concentration identified by a method, which preferably uses the CIE-xyz color space. This plane contains a chromatic point, which causes the slope of the calibration curve to be reversed at a specific reversal point.

In a second object of the invention, a colorimetric sensor array comprising a plurality of colorimetric sensors is described.

In a third object, the invention describes a process for preparing the sensor and the colorimetric sensor array.

In a fourth object, a method for measuring an analyte by means of the use of the colorimetric sensor array of the invention is described.

### BRIEF DESCRIPTION OF THE DRAWINGS

FIG. 1A shows an image of a CSA, consisting of an array of hand-deposited spots, with various molar ratios of Tetrabromophenol Blue (TBB)/Bromothymol Blue (BB) (above) or TBB/Phenol Red (PR) (below). The molar ratio increases in the direction of the arrows from bottom to top while pH increases from left to right.

FIG. 1B shows the components of the CSA calibration cell: a) Camera; b) Housing for the camera under which 6 LED D65s are circularly arranged; c) Circular support in which the sensor may be inserted.

FIG. 2 shows as an example the calibration curves of the indicators TBB, BB and PR. The repetition of the calibration curves verifies the reversibility of the sensor of the present invention.

### DETAILED DESCRIPTION OF THE INVENTION

For the purposes of the present invention, the term spot (or sensor) is intended as an area, preferably circular, resulting from the application of a preparation comprising an indicator and a surfactant on a support. In fact, it represents a single sensor.

For the present purposes, the term colorimetric sensor array (or simply array, or CSA=Colorimetric Sensor Array) is intended as a set of a plurality of spots on the same support.

Therefore, a first object of the invention is a colorimetric sensor comprising a preparation of a colorimetric indicator and a surfactant.

More in particular, this sensor is in the form of an organic-inorganic polymeric membrane.

This preparation is deposited and adsorbed on a solid porous support, in particular shortly after having been prepared in the form of sol, as detailed below.

According to an aspect of the present invention, the described sensor comprises a preparation of an indicator, a dye (which could also be an indicator) and a surfactant.

According to a particular aspect of the present invention, there may be two or more than two added dyes.

For example, the dyes used may be Bromocresol Green and Methyl Red.

For the purposes of the present invention, the support for the deposit is a porous PVDF membrane, having for example an average porosity of 0.2 μm (for example sold by Bio-Rad).

Advantageously, by varying the porosity of the support (PVDF 0.2 μm, Teflon 2.0 μm) it is possible to improve the kinetics of the sensor, and therefore the response time.

As regards the preparation of the membrane (in the form of sol), this comprises: precursors, an indicator with the solvent thereof, a surfactant and acid or basic water (milli-Q).

### Precursors

The following precursors may be used for the purposes of the present invention: TEOS (tetraethyl orthosilicate), methyltrimethoxysilane (MTES), ethyltriethoxysilane (ETES), phenyltrimethoxysilane (FTMS), ethyltriethoxysilane (octyl-TEOS), dodecyltriethoxysilane (dodecyl-TEOS), hexadecyltrimethoxysilane.

In a preferred aspect of the present patent application, at least two precursors are used for the preparation of the membrane, one of which is TEOS.

Even more preferably, the membranes are prepared starting from TEOS/octyl-TEOS.

Due to the presence of such precursors, the preparation is also referred to as OrMoSil.

### Indicator

The calibration sensitivity of a single sensor depends on the ratio ΔH/ΔpH, where ΔH is the difference value between the H values of the dissociated and undissociated form of the indicator and ΔpH is the pH range within which the H coordinate varies.

The maximum possible value of ΔH depends on the choice of the indicator but hardly exceeds the value of 0.55.

For the purposes of the present invention, an indicator is selected from the group comprising: Cresol Red; Metacresol Purple; Thymol Blue; Carmine; Tetrabromophenol Blue; Methyl Orange; 2-4-dinitrophenol; Bromophenol Blue; Congo Red; Ethyl Orange; Alizarin Violet N; Bromocresol Green; Methyl Red; Propyl Red; Chlorophenol Red; Basic Green 4; Bromophenol Red; Nitrazine Yellow; Purple Pyrocatecol Violet; Bright Yellow; Nile Red; Resazurin; Aurin; Bromothymol Blue; Phenol Red; Orange II; Phenolphthalein; Xylenol Blue; Nile Blue; Thiazole Yellow.

The indicators which work in a broad pH range are:

Bromophenol Blue (pH=1.50-6.50), a mixture of Bromocresol Green and Methyl Red (pH=2.00-8.00) and Bromothymol Blue (pH=5.80-13.50).

They are all characterized by a transition between complementary colors.

### Solvent

For the purposes of the present invention, the solvent is ethanol for almost all the indicators.

Nitrazine Yellow and Bright Yellow instead require 2-methoxy-ethanol.

### Surfactant

For the purposes of the present invention, the surfactant must be a cationic surfactant, therefore capable of minimizing the repulsions between silanol groups and negatively charged indicator molecules, especially in basic environments.

It has been surprisingly found that surfactants having a chain of 16 carbon atoms are advantageously capable of preventing smoothing and irreversibility phenomena, such as, for example, hexadecyltrimethylammonium p-toluenesulfonate (CTApTs).

Stability tests with analogous compounds which differ only by the chain length (C=8,10,12) have shown that the reversibility with chains shorter than C16 is incomplete.

C18 surfactants have an equally optimal sensitivity but the modulation of the H profile position occurs in a smaller pH range with respect to C16.

In a preferred aspect of the present invention, the surfactant/precursor ratio, and preferably of CTApTs/precursors, must be comprised between 0.05 and 0.40 g_{CTApTs}/g_{precursor}, and preferably between about 0.11 and 0.38 g_{CTApTs}/g_{precursor}.

### Dyes

Dyes which may be used for the purposes of the present invention are selected from the group comprising: Acid Green 25, Direct Blue 15, Trypan Blue, Methylene Blue.

Furthermore, some dyes may be used which by their nature are also indicators, such as, for example:

Tetrabromophenol Blue (TBB), Indigo Carmine (IC).

In accordance with a third object of the present patent application, the preparation of the sensor is obtained with a process comprising the steps of:
a) hydrolysis of the precursors,
b) addition of the cationic surfactant,
c) addition of a solution of the indicator dissolved in a suitable solvent, while stirring, or
d) addition of a solution of an indicator dissolved in a suitable solvent and a solution of a dye dissolved in a suitable solvent.

In step a), preferably the above-mentioned precursors are added to water in the presence of hydrochloric acid.

In a preferred aspect of the invention, two precursors are added to water, one of which is TEOS.

In particular, hydrolysis catalyst hydrochloric acid is preferably added up to a pH of about 2.00.

In a preferred aspect of the invention the two precursors are TEOS and Ottil-TEOS.

The hydrolysis is carried out until the phase separation disappears; for this purpose, vigorous magnetic stirring may be required for about an hour.

In step b), the surfactant is added in an amount such that the surfactant/precursor ratio is between about 0.11 and 0.38 g_{CTApTs}/g_{precursor}.

In step c) the solvent preferably is ethanol or 2-methoxy-ethanol, conveniently chosen as a function of the indicator.

According to a particular aspect of the present invention, in step d) there may be two or more than two added dyes.

For example, the dyes used may be Bromocresol Green and Methyl Red.

In preferred aspects of the invention, the indicator concentration (in mg) for each gram of sol comprising precursors, water, hydrochloric acid, and surfactant (excluding the indicator solvent) is approximately:

| Indicator | Range (mg) | Amount (mg) |
|---|---|---|
| Bromochlorophenol blue (BCPB) | 6.5-6.7 | 6.61 |
| Bromocresol green (BCG) | 7.5-8.1 | 7.94 |
| Thymol blue (TB) | 0.80-1.0 | 0.90 |
| Bromothymol blue (BB) | 6.90-7.20 | 7.10 |
| Nitrazine yellow (NY) | 6.10-6.22 | 6.17 |
| Tetrabromophenol blue (TBB) | 8.9-9.1 | 8.97 |
| Bright yellow (BY) | 7.0-7.2 | 7.10 |
| Methyl red (MR) | 2.9-3.1 | 3.06 |
| M-cresol purple (CP) | 4.30-4.4 | 4.35 |
| Phenol red (PR) | 3.9-4.1 | 4.03 |
| Cresol red (CR) | 3.4-3.55 | 3.48 |
| Xylenol blue (XB) | 0.80-1.0 | 0.90 |
| Cresol purple (CP) | 3.4-3.55 | 3.48 |

Stirring may also be carried out for about 10 minutes.

More generally, the preparation of a colorimetric sensor may be prepared starting from:

| Precursors | 5.0-6.0 | g |
|---|---|---|
| Water | 2.0-2.5 | g |
| Hydrochloric acid | as needed up to approx. | |
| | pH 2.00 | |
| Surfactant | 0.4-2.1 | g |
| Indicator | 0.8-9.1 | mg |
| Solvent | 6.3-8.1 | g |
| Dye | 0-3.0 | mg |

To optimize the sensitivity of some indicators, it is possible to conduct a step d) in which a solution of one or two dyes (which could be, by their nature, independently of each other, indicators) is added to the sol of the indicator; in this way a preparation comprising an indicator and one or two dyes (or dye(s)/indicator) is obtained.

In preferred aspects of the present invention, the ratios between the indicator the performance of which is to be improved and the dye may be those reported in the following table:

0.01<n_{TBB}/n_{XB}<0.19

0.18<n_{TBB}/n_{MR}<0.35

0.186<n_{TBB}/n_{PR}<0.324
TBB=Tetrabromophenol Blue
XB=Xylenol Blue
MR=Methyl Red
PR=Phenol Red

According to an aspect of the present invention, in step c) or d) one or more additives capable of giving rise to chemical reactions with variation of pH may be added.

For this purpose, palladium chloride (II) and/or diethylethanolamine (DEEA) may be added.

The solution obtained (from step c) or from step d)) is then deposited on the support membrane, preferably

PVDF, and is stored in a dry place protected from light for a period, for example three days, until completion of the polymerization.

For the purposes of the present invention, the deposition is carried so as to form spots with a diameter of a few mm.

The amount of sol deposited for each spot is about 90-105 μg, preferably about 95 μg.

A spot (single sensor) or a plurality of spots (thus forming the colorimetric sensor array), each of which comprises an indicator, is deposited on the support.

In an array, each spot stands out from the other spots for the concentration of surfactant and/or for the amount of solvent used and/or for the indicator and/or for the added additives.

According to an aspect of the invention, the array may comprise sensors, each of which comprises a different concentration of precursor, and in a preferred aspect, of OrMoSil precursors.

The CSA preparation process may end, after step c) or step d), with the calibration step; this step is carried out by the manufacturer, since the deposition procedure is reproducible in time and space.

The support is then subjected to the steps of:

maintenance at pH=1 for about 2 minutes and then washing with water (milli-Q),

maintenance at pH=12 for about 2 minutes and then washing with water (milli-Q),

maintenance at pH=1 for about 2 minutes and then washing with water (milli-Q).

During calibration, the support is immersed in various acid pH to basic pH buffer solutions for approximately 30-40 seconds, until equilibrium is reached for the H coordinate of the HSV color space.

According to an alternative aspect of the present invention, step a) and step b) of the process described above may be replaced by a step of preparing a first sol comprising TEOS and 3-methacryloxypropyl-trimethoxysilane (MAPTMS) and a second sol comprising zirconium tetrapropoxide (ZTP) and methacrylic acid.

The second sol may comprise titanium tetrapropoxide (TTP) and/or titanium isopropoxide (TTIP) as an alternative to ZTP.

After the hydrolysis step of each sol, the two sols are mixed together.

According to an alternative aspect of the present invention, the colorimetric sensor array does not comprise a plurality of spots physically separated and spaced from each other, but may instead be prepared so as to comprise a continuous preparation (membrane in the sol phase) (hereinafter referred to as STRIP), characterized by a non-constant amount of surfactant and/or solvent throughout the surface of the support and which, for example, increasingly or decreasingly vary continuously along one of the dimensions of the support.

According to a further aspect of the present invention, several STRIPs characterized by a different indicator may be placed side by side.

The colorimetric sensor of the invention is suitable not only for measuring pH but also for measuring other analytes, including, for example: amines, ethylene, carbon monoxide, carbon dioxide, sulfur dioxide, glucose, sugars.

In this case, it may be necessary to include further additives in the preparation of the indicator such as: palladium chloride (II) or diethylethanolamine (DEEA), which give rise to chemical reactions with variation of pH, and therefore color change of the individual spots.

In a fourth object, a method for measuring an analyte by means of the use of the colorimetric sensor array of the invention is described.

In particular, this analyte may be pH or other analytes, including, for example: carbon dioxide, carbon monoxide, sulfur dioxide, amines, ethylene, sulfur dioxide, glucose, sugars.

Consequently, the described method allows to detect pH, presence of carbon dioxide, carbon monoxide, sulfur dioxide, amines, ethylene, sulfur dioxide, glucose, sugars.

In a preferred aspect of the invention, the described sensor is a pH sensor.

For the purposes of the present invention, the pH measurements are based on the Hue profile (H) of the HSV color space.

According to the present invention, after having been in contact with the analyte, a photographic image of said sensor or said array (i.e., of each sensor of said array) is acquired.

The H coordinate of a portion of each image is acquired, preferably as the median value of the pixels of the most homogeneous and saturated portion of each spot.

The acquisition of the color coordinates is preferably optimized if constant illumination is maintained with a D65 LED (medium sunlight).

### EXAMPLE 1

### Preparation of the Membrane

Two vials are prepared, of which one corresponding to the lowest surfactant concentration (about 0.11 g_{CTApTs}/g_{precursor}; LOW) and one corresponding to the highest surfactant concentration (about 0.38 g_{CTApTs}/g_{precursor}; HIGH) starting from:

grams

| Component | LOW | HIGH |
|---|---|---|
| Water | 1.82 | 1.82 |
| HCl | 0.64 | 0.64 |
| CTApTS | 2.01 | 0.60 |
| Octyl-TEOS | 0.75 | 0.75 |
| TEOS | 4.64 | 4.64 |
| Gel/portion | 9.86 | 8.45 |
| Solvent | 7.36 | 6.35 |

The amount in mg of each indicator used is the same for the two vials:

| Indicator | Range (mg) | Amount (mg) |
|---|---|---|
| Bromochlorophenol blue (BCPB) | 6.5-6.7 | 6.61 |
| Bromocresol green (BCG) | 7.5-8.1 | 7.94 |
| Thymol blue (TB) | 0.8-1.0 | 0.9 |
| Bromothymol blue (BB) | 6.90-7.20 | 7.10 |
| Nitrazine yellow (NY) | 6.10-6.22 | 6.17 |
| Tetrabromophenol blue (TBB) | 8.9-9.1 | 8.97 |
| Bright yellow (BY) | 7.0-7.2 | 7.10 |
| Methyl red (MR) | 2.9-3.1 | 3.06 |
| M-cresol purple (CP) | 4.30-4.4 | 4.35 |
| Phenol red (PR) | 3.9-4.1 | 4.03 |
| Cresol red (CR) | 3.4-3.55 | 3.48 |
| Xylenol blue (XB) | 0.8-1.0 | 0.9 |
| Cresol purple (CP) | 3.4-3.55 | 3.48 |

From the two vials, once the indicator solution has been added, all the possible arrays with intermediate surfactant concentrations are obtained. The amount of solvent in the two vials (LOW, HIGH) is different to allow for a similar slope of the sigmoid of H vs pH throughout the surfactant modulation range.

### EXAMPLE 2

### Measurement Reversibility

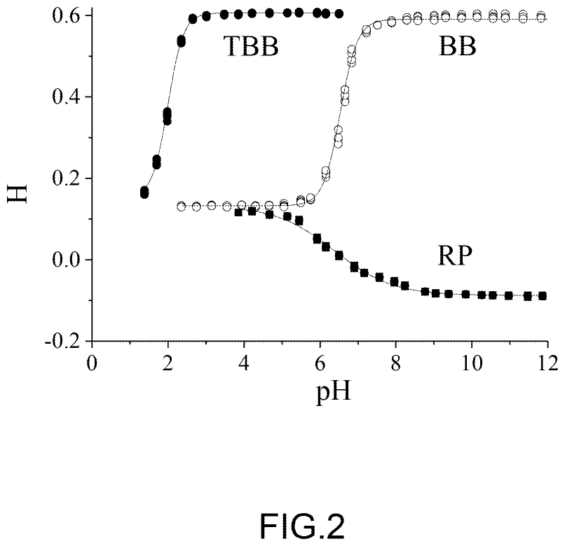

FIG. 2 shows the results of an assay to verify the reversibility of the system of the present invention.

In the test illustrated, the profiles have already undergone a conditioning cycle demonstrating the high system reversibility. The fitting is related to the experimental points (about 150 for each indicator, performed on 5 identical spots) of TBB=Tetrabromophenol Blue, BB=Bromothymol Blue, PR=Phenol Red. The experimental data are obtained by immersing the sensor in different buffers from pH 1 to 12. The experimental point at pH=6.865 is obtained with a standard buffer to the third decimal place and perfectly matches the experimental data fittings.

### EXAMPLE 3

Calculation of the error on the discriminated pH and decrease of the error with the increase in the number of spots.

Using a single spot sensor with TBB indicator and CTApTs surfactant at concentration 0.38 g_{CTApTs}/g_{precursor} the pH prediction error, referred to as s_{pH} is equal to 0.012 at pH=2.20.

With just two identical spots it decreases to s_{pH}=0.008.

By adding 15 spots with different concentrations of CTApTs in the range 0.11-0.38 g_{CTApTs}/g_{precursor}, the same precision is obtained throughout the range between pH=2 and pH=4. Since the spots have a diameter of 3 mm, an increase in the number thereof does not cause problems from a sensor size point of view.

### EXAMPLE 4

### Preparation of a CSA Array According to the Invention

OrMoSil sol was prepared by mixing the main components in this order: 4.03 g of TEOS, 0.65 g of Dodecyl-TEOS, 1.58 g of Milli-Q water and 0.55 g of aqueous solution of HCl at pH=2.03. After 40-45 minutes under magnetic stirring at room temperature, the initial cloudy solution became transparent, due to the disappearance of the phase separation. 1.75 g of CTApTs cationic surfactant was then added, followed by stirring for 30 minutes. The pH indicator solution was then added to the sol under stirring for a further 5 minutes. The solutions of BB (bromothymol blue), TBB (tetrabromophenol blue) and PR (phenol red) were obtained by mixing 50.5, 79.7, 28.7 mg of indicator, respectively, in 6.40 g of ethanol. The total weight of each sol solution is 8.56 g. The sols of the individual indicators were then conveniently mixed. The amount of sol TBB added to the PR and BB vials corresponds to: 0 g, 0.3 g, 0.7 g, 1.1 g, 1.6 g, 2.1 g, 2.7 g, 3.7 g, and 5.4 g corresponding to a TBB molar/indicator ratio of: 0, 0.026, 0.061, 0.096, 0.140,0.184, 0.236, 0.324, 0.473, respectively.

PVDF supports (6×3.5×0.1 cm) were used as solid supports on which the OrMoSil sol was deposited through a steel bar (filed base with 1.6 mm diameter) at 20±2° C. The calibration was carried out in accordance with the description in the present patent application.

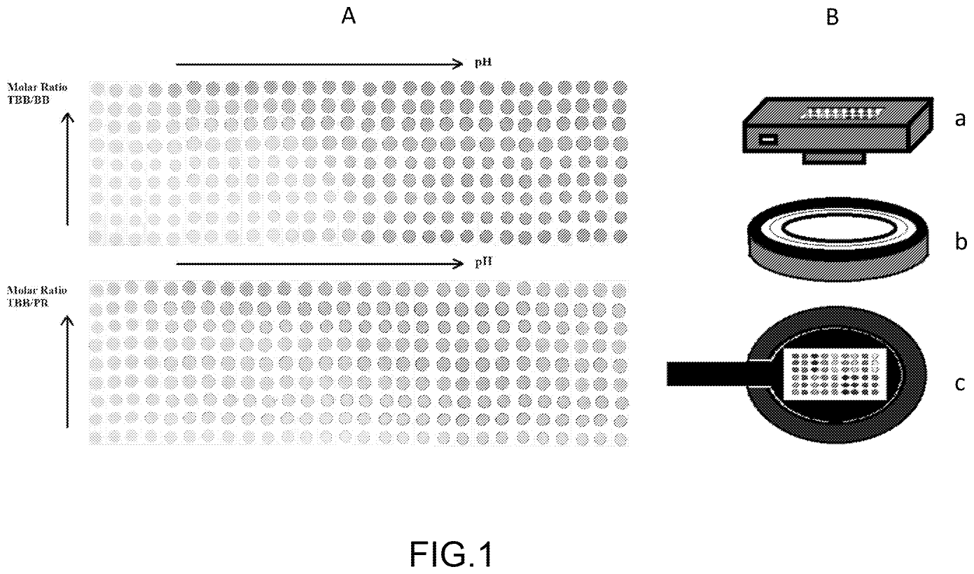

The array thus obtained is shown in FIG. 1.

From the above description, the benefits offered by present invention will be immediately apparent to those skilled in the art.

First, the sensor described considerably reduces the prediction error associated with the pH measurement, which is comparable with that typical of potentiometric measurements (<0.02 pH units) due to the modulation of the surfactant concentration.

In the case of an indicator characterized by a transition between non-complementary colors, the range within which the addition of a dye actually leads to an improvement in the precision and accuracy of the pH measurement has been identified.

In particular, a sensor was obtained capable of providing high accuracy in a wide pH range (up to 7 pH units), due to the modulation of the pKa of the indicator used.

Furthermore, the sensor is reversible and may therefore be reused.

The pH measurement is carried out with response times around ten seconds.

The H coordinate (hue) of the HSV color space (hue, saturation, value) used for the measurements is stable, simple to calculate and easily obtainable from commercial devices, maintaining better accuracy with variations in indicator concentration, membrane thickness and illumination, compared to the other color spaces.

A considerable benefit is the possibility of the manufacturer carrying out the calibration on a membrane only once.

Moreover, spots with the same composition have identical profiles in time and space, with time savings with respect to the potentiometric method.

The device also lends itself to online measurements due to the use of a porous support such as PVDF; in fact, the permeation of Ormosil also from the opposite side of the PVDF sheet is possible due to the surfactant which reduces the surface tension, also allowing the pH measurement of turbid samples.

In addition, the device is suitable for measurements in sea water (pH=7.0-8.5) where the high ionic strength of the solution results in a considerable variation of the electrode joint potential in glass.

The temperature dependence of the calibration profiles in the 10-30° C. range has proven to be negligible.

In the aspect of the invention comprising a membrane based on the preparation of a first sol comprising TEOS and 3-methacryloxypropyl-trimethoxysilane (MAPTMS) and a second sol comprising zirconium tetrapropoxide (ZTP) and methacrylic acid, the applicability of the sensor of the invention reaches pH=13, where the pH meter is instead affected by a high alkaline error already at pH>11 and at pH>12 the response times begin to be extremely slow and above a minute.

The size of the spots is very small (around 1 mm in diameter), allowing to prepare portable, low-cost sensors.

1. A colorimetric sensor comprising an indicator and a surfactant.

2. A colorimetric sensor according to the preceding claim, further comprising a dye or a combination of two or more dyes.

3. A colorimetric sensor according to claim 1 or 2, wherein said indicator is selected from the group comprising: Cresol Red; Metacresol Purple; Thymol Blue; Carmine; Tetrabromophenol Blue; Methyl Orange; 2-4-dinitrophenol; Bromophenol Blue; Congo Red; Ethyl Orange; Alizarin Violet N; Bromocresol Green; Methyl Red; Propyl Red; Chlorophenol Red; Basic Green 4; Bromophenol Red; Nitrazine Yellow; Purple Pyrocatecol Violet; Bright Yellow; Nile Red; Resazurin; Aurin; Bromothymol Blue; Phenol Red; Orange II; Phenolphthalein; Xylenol Blue; Nile Blue; Thiazole Yellow.

4. A colorimetric sensor according to any one of the preceding claims, wherein said surfactant is a cationic surfactant.

5. A colorimetric sensor according to any one of the preceding claims, wherein said surfactant is hexadecyltrimethylammonium p-toluenesulfonate (CTApTs).

6. A colorimetric sensor according to any one of the preceding claims, further comprising one or more additives capable of giving rise to chemical reactions with variation of pH.

7. A process for obtaining a colorimetric sensor preparation according to any one of the preceding claims, comprising the steps of:
a) hydrolysis of the precursors,
b) addition of the cationic surfactant,
c) addition of a solution of the indicator dissolved in a suitable solvent, while stirring, or
d) addition of a solution of an indicator dissolved in a suitable solvent and a solution of one, two or more dyes dissolved in a suitable solvent.

8. A process according to the preceding claim, wherein said precursors are selected from the group comprising: TEOS (tetraethyl orthosilicate), methyl-trimethoxysilane (MTES), ethyl-triethoxysilane (ETES), phenyltrimethoxysilane (FTMS), octyltriethoxysilane (octyl-TEOS), dodecyl-triethoxysilane (dodecyl-TEOS), hexadecyl-trimethoxysilane, zirconium tetrapropoxide (ZTP), 3-methacryloxypropyl-trimethoxysilane (MAPTMS), titanium tetrapropoxide (TTP), titanium isopropoxide (TTIP).

9. A process according to claim 7 or 8, wherein said step a) comprises the addition of an acid up to a pH of about 2.00.

10. A process according to any one of the claims 7 to 9, wherein the surfactant is added in an amount such that the surfactant/precursor ratio is preferably comprised between about 0.11 and 0.38 g_{CTApTs}/g_{precursor}

11. A process according to any one of the claims 7 to 10, wherein in step c) or step d) one or more additives capable of giving rise to chemical reactions with variation of pH are added.

12. A colorimetric sensor array comprising a plurality of sensors according to any one of the preceding claims 1 to 6.

13. A colorimetric sensor array according to the preceding claim, wherein each colorimetric sensor comprises a different indicator and/or a different dye or different dyes with respect to the other sensors.

14. A colorimetric sensor array according to any one of the claim 12 or 13, wherein each colorimetric sensor comprises a different concentration of surfactant.

15. A colorimetric sensor array according to any one of the claim 12 or 13 or 14, wherein each colorimetric sensor comprises a different concentration of OrMoSil precursors.

16. An array of colorimetric sensors comprising a preparation of an indicator and a surfactant, and possibly one, two or multiple dyes, characterized by a non-constant amount of surfactant and/or solvent throughout the surface thereof.

17. A method for preparing an array according to any one of the claims from 12 to 16, comprising the step of applying to a solid support a plurality of colorimetric sensors according to any one of the claims 1 to 6, wherein the at least one colorimetric sensor comprises a different indicator and/or a different dye and/or comprises a different concentration of surfactant and/or a different concentration of OrMoSil precursors and/or is made using a different amount of solvent and/or comprises one or more additives.

18. A method for measuring an analyte of a solution comprising the steps of:
placing the analyte in contact with the sensor or colorimetric sensor array according to any one of the claims 1 to 6 or 12 to 17,
acquiring a photographic image of said sensor or said array,
acquiring the H coordinate of a portion of each image.

19. A method according to the preceding claim, wherein said step of acquiring the H coordinate is conducted online.

20. A method according to any one of the claims 17 to 18, wherein said analyte is pH, carbon dioxide, carbon monoxide, sulfur dioxide, amines, ethylene, sulfur dioxide, glucose, sugars.
